(19) United States
(12) Patent Application Publication
(10) Pub. No.: US 2016/0255803 A1
(43) Pub. Date: Sep. 8, 2016

(54) Pet Bed

(71) Applicant: Sergei C. Baranoff, West Sacramento, CA (US)

(72) Inventor: Sergei C. Baranoff, West Sacramento, CA (US)

(21) Appl. No.: 15/059,260

(22) Filed: Mar. 2, 2016

Related U.S. Application Data
(60) Provisional application No. 62/127,396, filed on Mar. 3, 2015.
(60) Provisional application No. 62/202,781, filed on Aug. 7, 2015.

(51) Int. Cl. A01K 1/035; A47C 21/00

(52) U.S. Cl. CPC A01K 1/0353; A47C 21/00

(57) ABSTRACT

A pet bed system is configured to be secured to a bed of a pet owner. This allows a pet owner to prevent the pet from constraining the pet owner's bed space. The pet bed system is secured to the bed by inserting a base segment between a box spring and a mattress. A vertical beam connected to the base segment supports a platform, which holds the pet bed. The vertical beam can be adjustable, allowing the pet bed to be positioned at various heights relative to the mattress. The segments are connected to each other via foldable hinges. The segments of the pet bed system can be folded upon each other, providing a compact configuration for storage when not in use.

### CROSS REFERENCE TO RELATED APPLICATIONS

This application claims the benefit of U.S. Provisional Application No. 62/127,396, filed Mar. 3, 2015, and U.S. Provisional Application No. 62/202,781, filed Aug. 7, 2015, each of which is incorporated by reference in its entirety.

### BACKGROUND

This invention relates generally to animal furniture and more particularly to pet beds.

Presently, in-home pet beds are designed to be placed upon the floor of a home; however it is common that pets, e.g. dogs and cats, sleep in the beds of their owners during the day as well as night. This act poses a problem for many pet-owners, as the pets move about and constrain the sleeping space of the owner. Furthermore, the owner must be cognizant while sleeping to not kick, rollover, or hurt their pet.

Rather than helping users address these issues, standard practice is for the user to adapt to the pet sleeping in bed. Accordingly, there is a longstanding need for an effective, non-intrusive system that limits or completely eliminates the owner's need to adapt and make space for a pet in their bed.

### SUMMARY

To address these problems, embodiments of the invention provide an effective system for affixing a pet bed to other furniture, such as a bed. Various embodiments of the system provide flexibility in configuring the pet bed system, including the ability for the pet bed to remain affixed to the base while in both the vertical and horizontal position, providing for a multi-faceted foldable, storable, and secure sleeping surface. The pet bed is configured with a base that is positioned between a mattress and a box spring. An adjustable beam allows the pet bed to be positioned at various heights relative to the mattress. In one embodiment, hinge connections between the segments of the pet bed allow the segments to fold onto each other into a compact configuration for storage.

### BRIEF DESCRIPTION OF THE DRAWINGS

FIGS. 1A and 1B illustrate embodiments of a pet bed system.

FIG. 2 illustrates a method for securing a pet bed to a pet bed system, according to one embodiment.

FIG. 3 illustrates a pet bed system in a compact configuration for storage, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

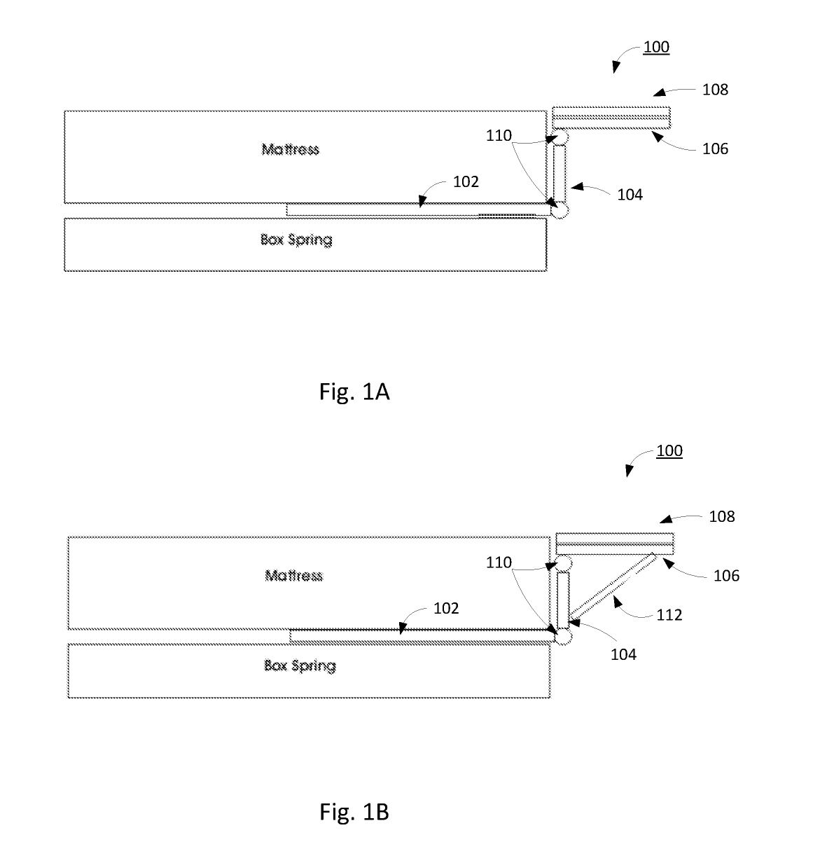

FIGS. 1B and 1B illustrate embodiments of a pet bed system. The pet bed system 100 includes multiple segments, such as base 102, beam 104, beam 106, and platform 108. A first end of the beam 104 is affixed to the base 102 by a first hinge 110, and a second end of the beam 104 is affixed to the beam 106 by a second hinge 110, as illustrated in the embodiment of FIG. 1A. The base 102 is configured to be placed between a mattress and a box-spring of a bed to securely and stably position the pet bed system 100. The beam 104 extends vertically upward from the base 102 and against the bed mattress. The beam 106 extends horizontally outward from the beam 104 and provides a base for the platform 108, on which the pet bed rests. The platform 108 is secured to the beam 106 by mechanical fasteners, adhesives, or any other suitable securing mechanism, or a combination thereof. In some embodiments, the beam 104 is adjustable and allows the pet bed to be positioned at various heights relative to the bed mattress. In the embodiments of FIGS. 1A and 1B, the plurality of hinges 110 are foldable hinges that allow the beam 106 and the platform 108 to fold down against beam 104 into a vertical position when the pet bed is not in use. The segments base 102, beam 104, beam 106, and platform 108 may be composed of wood, metal, plastic, or other suitable materials. The material of each segment may be uniform or may differ.

In the embodiment of FIG. 1B, the beam 106 is supported by an arm 112, which provides support and stability for the beam 106 and the platform 108. The arm 112 can be affixed to the beam 104 by a foldable hinge, allowing the support arm to be dropped down when not in use. When the arm 112 is in use, the arm can be removeably secured to the beam 106 by a hook, bracket, or any other suitable mounting component. The arm 112 may be comprised of wood, metal, plastic, or other suitable materials. To further support the weight of the beam 106 and the platform 108, the arm 112 may be supplemented by other suitable means of support, such as drop-down legs, collapsible bars, or the like. These alternatives may be used alone or in conjunction with another.

In other embodiments, the pet bed may be replaced by other objects affixed to the pet bed system 100. For example, the pet may be replaced by a formed tray, boxes, or wired electrical housing to allow for various configurations by the user while using the same support structure described in FIG. 1A or 1B, further optimizing the utility of the unit by the user.

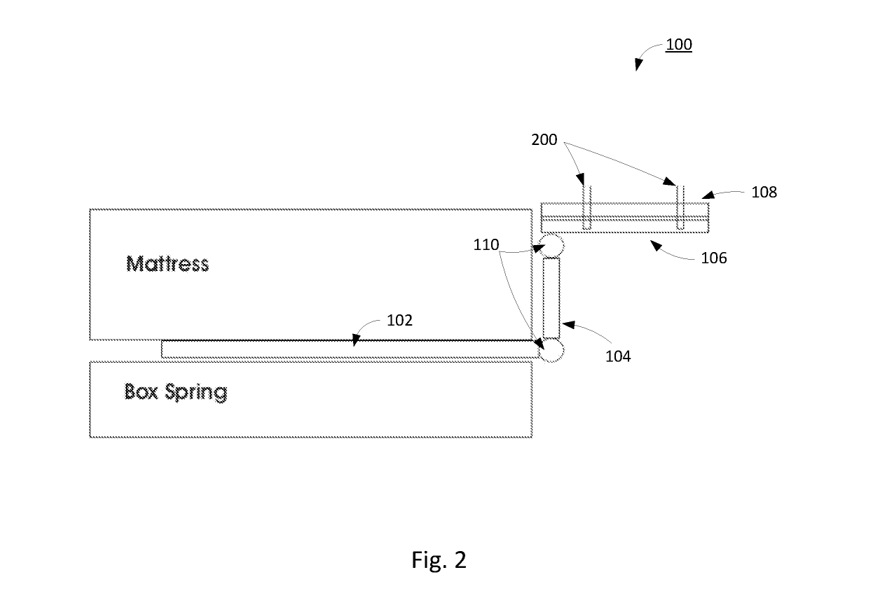

FIG. 2 illustrates a method for securing a pet bed to a pet bed system, according to one embodiment. The platform 108 may include methods of affixation for the pet bed to the pet bed system 100. These methods may include but are not limited to mechanical fasteners 200, friction glues, adhesives, or the like. In some embodiments, the pet bed may be permanently or removeably secured to the platform 108. These means allow for the pet bed to remain affixed to the platform 108 while the pet bed system 100 is in use in the horizontal position and while not in use in the vertical position.

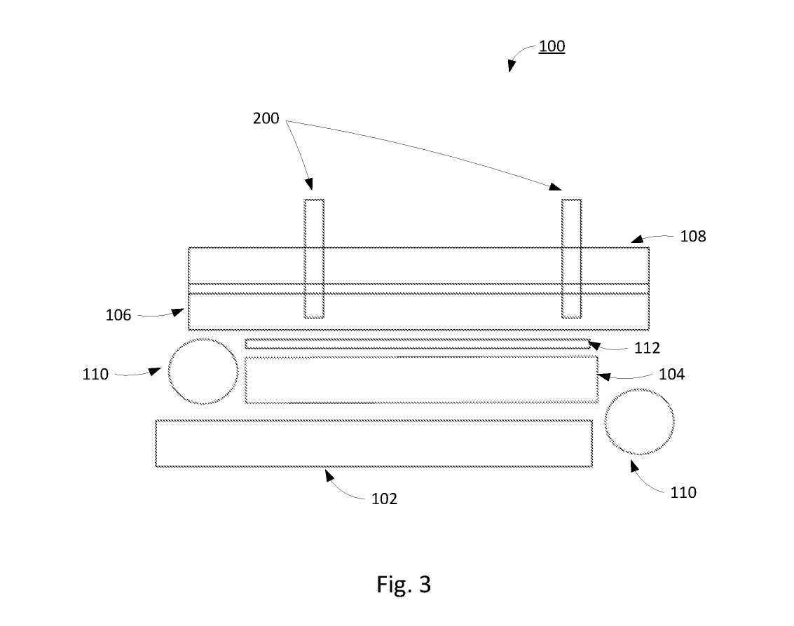

FIG. 3 illustrates a pet bed system in a compact configuration for storage, according to one embodiment. As illustrated in the embodiment of FIG. 3, the beam 106 and the platform 108 collapse upon the beam 104 with the arm 112 folded in-between, and the beam 104 collapses upon the base 102. The segments are able to collapse upon another due to the plurality of hinges 110, which are foldable in the embodiment of FIG. 3, that connect the segments to each other. The compact configuration allows for flat storage of the entire pet bed system 100.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A pet bed system comprising:
a base segment;
a first beam segment, wherein a first end of the first beam segment is hingedly connected to a first end of the base segment;
a second beam segment, wherein a first end of the second beam segment is hingedly connected to a second end of the first beam segment;
a platform secured to the second beam segment, wherein the platform is configured for holding a pet bed.

2. The pet bed system of claim 1, wherein the base segment is configured to be placed between a mattress and a box-spring of a bed.

3. The pet bed system of claim 1, wherein the first beam segment is a beam configured to extend vertically against the side of the mattress.

4. The pet bed system of claim 1, wherein the length of the first beam segment is configured to be adjustable, allowing the platform of the pet bed system to be positioned at various heights relative to the mattress.

5. The pet bed system of claim 1, wherein the platform has securing mechanisms to secure a pet bed.

6. The pet bed system of claim 1, wherein the hinges that connect each of the segments are foldable.

7. The pet bed system of claim 1, wherein the second beam segment and the platform fold down against the first beam segment when not in use.

8. The pet bed system of claim 1, wherein the pet bed system has a compact configuration for storage, in which each of the segments fold upon each other.

9. The pet bed system of claim 1, wherein a beam extends from the first beam segment to a portion of the second beam segment distal from the first end of the second beam segment, providing support for the second beam segment and the platform.

10. The pet bed system of claim 9, wherein the beam is hingedly connected to the first beam segment, allowing the beam to fold down when not in use.
